(19) United States
(12) Patent Application Publication
(10) Pub. No.: US 2005/0044023 A1
(43) Pub. Date: Feb. 24, 2005

(54) SYSTEM AND METHOD FOR CREATING TRADEABLE FINANCIAL UNITS

(75) Inventors: Earl Rotman, Toronto (CA); William S. Schreier, New York, NY (US); Jeffrey Berson, Mamaroneck, NY (US)

Correspondence Address: DARBY & DARBY P.C., P. O. BOX 5257, NEW YORK, NY, 10150-5257, US

(73) Assignee: CIBC WORLD MARKETS, New York, NY (US)

(21) Appl. No.: 10/709,329

(22) Filed: Jul. 15, 2004

Related U.S. Application Data
(60) Provisional application No. 60/539,526, filed on Jan. 26, 2004.

(51) Int. Cl. G06F 17/60

(52) U.S. Cl. 705/35; 705/36

(57) ABSTRACT

An article suitable for trade as a unit in a financial offering by a company, representing in a predetermined ratio both equity and debt, while providing direct ownership of the equity and debt. The debt is interest bearing at a particular rate until a particular maturity date. An article suitable for trade as a unit in a subsequent offering further includes a second debt, which is interest bearing at the same particular rate until the same particular maturity date as the first debt. A software reference can associate the equity and debt(s) of the unit to a unique number that is suitable for facilitating the clearing and settlement of purchases and sales. The unit provides direct ownership of the equity and debt without an intervening holding entity or the need for trust certificates. Methods establishing such units and for decomposing them are described.

### CROSS REFERENCE TO RELATED APPLICATIONS

This application claims the benefit of priority under 35 U.S.C. § 119(e) to U.S. Provisional Application No. 60/539,526, filed Jan. 26, 2004, titled “SYSTEM AND METHOD FOR THE CREATION AND DISTRIBUTION OF INCOME DEPOSIT SECURITIES,” hereby incorporated by reference in its entirety.

### FIELD OF THE INVENTION

The present invention relates to offerings of securities of a company, and in particular to the creation and offering of tradeable units, and methods relating to same. A tradeable unit representing both equity and debt of the company is constructed according to a predetermined ratio for the offering.

### BACKGROUND OF THE INVENTION

When a private business seeks additional financing its choices are generally limited to either internal or external financing. Existing working capital, cash flow and profits limit internally-financed growth and generally impact the availability of external financing.

Conducting an Initial Public Offering (IPO) gives a company many advantages including greater visibility in the marketplace, heightened legitimacy with customers, partners and vendors, and easier access to the capital marketplace. However, a private company's ability to raise funds in an IPO has certain limitations. The IPO marketplace generally favors companies with high growth characteristics, such as those involved in leading edge technologies or businesses; whereas mature, stable and modestgrowth companies are often not well-received by, or are otherwise unable to successfully access the IPO marketplace.

In Canada, mature, stable and modest-growth companies are able to successfully access the IPO marketplace to raise public capital through the use of a vehicle known as an Income Trust. Under this Income Trust structure, a company issues subordinated debt and common shares to a trust which is organized exclusively for this purpose. The trust obtains the funding to purchase such debt and equity of the company by selling trust certificates which constitute an ownership interest in the trust to the public. The trust's trustees have discretion to issue dividends to trust certificate holders consistent with their fiduciary responsibility to the trust. Thus, through this Income Trust vehicle, a company is able to raise public capital even though it may not be an otherwise traditionally attractive candidate for the IPO marketplace.

However, in the Income Trust vehicle, owners of the trust certificate have no direct ownership interest in either the equity or the subordinated debt of the company. Instead they have an ownership interest in the trust itself, and they derive their income from the interest and dividends paid to the trust. The holders of the trust certificates do not have any direct voting rights over or control of the company whose securities are held by the trust. The Income Trust structure is very popular in Canada to both companies and investors, but its structure is not desirable for the U.S. market, not only because it lacks direct ownership, but also because the U.S. legal and regulatory framework makes it practically impossible to replicate here. Even if the income structure was replicated in the U.S., the company management acting as trustees of the trust would not be well received or accepted in the marketplace.

Accordingly, there is a need for a financial unit which provides capital raising capability to certain companies, while also providing holders of the financial unit with direct ownership interest in the equity and the debt of a company. Such a financial unit's structure is capable of fulfilling the needs of public investors for a high current yield security, which at the same time provides direct ownership in the securities comprising the tradeable unit, while also overcoming the historical reluctance of investors to participate in public offerings for companies that have lower growth profiles and are typically not favored by the IPO marketplace. Further, missing from the art is a tradeable unit for a company representing the equity and the debt which is fully fungible with prior series of similarly structured units. The present invention can satisfy one or more of these and other needs.

### SUMMARY OF THE INVENTION

The present invention relates to capital offerings by a company and provides a financial unit representing both equity and debt ownership interests in a company, which is suitable for the capital offering. In accordance with one aspect of the invention, an article suitable for trade as a unit represents equity shares and debt in a prescribed way and in a predetermined ratio, while providing direct ownership of the equity shares and debt.

In accordance with another aspect of the invention, an article suitable for trade as a unit in a subsequent offering includes a second debt, which is interest bearing at the same rate as, and until the maturity date of, a first debt. The equity shares and debts are represented in the predetermined ratio while providing direct ownership of the equity shares and debts.

In accordance with yet another aspect of the invention, a software reference associates the equity and debt of the tradeable unit to a unique number that is suitable for facilitating the clearing and settlement of any purchases and sales of the tradeable unit.

In accordance with a further aspect of the invention, a method establishes an article suitable for trade as a unit in an offering by the company and includes the steps of defining a capital structure that includes equity shares of the company and debt of the company in a predetermined ratio, submitting a request to register the equity and debt for the offering, requesting the association of these securities, depositing the debt and equity together under a single, unique number which represents both the equity and debt, and offering the tradeable unit for purchase and sale.

A method for establishing follow-on tradeable units for subsequent offerings according to still further aspects of the invention includes the steps of defining a capital structure that includes additional equity shares and additional debt in the predetermined ratio, recalling the first tradeable unit and requesting the disassociation of its constituent components, requesting the association of the constituent components and the additional equity and additional debt according to the same predetermined ratio, depositing the components, additional equity and additional debt together under a single, unique number which represents all of the deposited securities, and offering the tradeable unit for purchase and sale.

In accordance with yet another aspect of the invention, a method for marketing constituent components of a tradeable unit, which is identified by a unique reference number and jointly represents equity and debt as its constituent components, includes the steps of obtaining dominion over the tradeable unit from a holder, separating the constituent components, and effecting the transfer of the equity or debt from the holder.

These and other aspects, features, steps and advantages can be further appreciated from the accompanying drawing Figures and description of certain illustrative embodiments.

### BRIEF DESCRIPTION OF THE DRAWING FIGURES

FIG. 1 is a flow diagram illustrating steps in accordance with an embodiment of the invention;

FIG. 2 is a flow diagram illustrating steps in accordance with another embodiment of the invention;

FIG. 3 is a flow diagram illustrating steps further incorporated within the embodiment illustrated in FIG. 1;

FIG. 4 is a flow diagram illustrating steps further incorporated within the embodiment illustrated in FIG. 2;

FIG. 5 is a flow diagram illustrating steps in accordance with a third embodiment of the invention;

FIG. 6 depicts the structure of the tradeable units created by the embodiment shown in FIG. 1;

FIG. 7 depicts the structure of the tradeable units created by the embodiment shown in FIG. 2; and

FIG. 8 depicts the capital structure for a company resulting from the embodiments shown in FIGS. 1 and 2.

### DETAILED DESCRIPTION OF THE ILLUSTRATIVE EMBODIMENTS

By way of overview and introduction, presented and described are embodiments of an article suitable for trade as a unit, where the article is a tradeable unit representing both the equity and the subordinated debt of a company. Preferably, the tradeable unit is a registered security that is suitable for a public offering of the company. The tradeable unit can be designed to allow the company to distribute nearly all of its free cash flow to its investors and to be a financially engineered security which represents a predetermined ratio of equity and subordinated debt issued by a company. The tradeable unit can generate a high current return on an investor's capital with some additional modest growth potential, while also creating an efficient capital structure for the company. The current yield can be engineered to return a desired return on capital. Under current conditions present in the marketplace, this yield is expected to be between 8 and 12 percent. However, a person of ordinary skill in the art knows that as conditions change the expected yield is subject to change either upwards or downwards.

Several embodiments are presented which include subordinated debt in the tradeable unit. Senior subordinated debt can be within the scope of these embodiments. Further, the invention is not limited to embodiments which only include subordinated debt in the tradeable unit. Embodiments which include only senior debt are also within the scope of the invention, as well as embodiments which may include senior debt, senior subordinated debt and subordinated debt, in any combination.

A candidate company for the creation and offering of these tradeable units preferably has a historical growth rate that is modest, stable and predictable. Such a company may have long-term and exclusive contracts or a protected position within its business sector, and/or a diversified customer base which better assures that the candidate company's business is stable and predictable. Desirably, a candidate company has predictable capital expenditure requirements and has experienced senior management, but lacks sufficient opportunities to invest its free cash flow at attractive rates of return.

The article suitable for trade as a unit, which is an embodiment of the invention, is also referred to as an Income Deposit Security (IDS), e.g., in Securities and Exchange Commission filings made by the present assignee. The terms “article”, “unit”, “tradeable unit”, “Income Deposit Security” and “IDS” are used interchangeably throughout the disclosure and each term has the same meaning as the other.

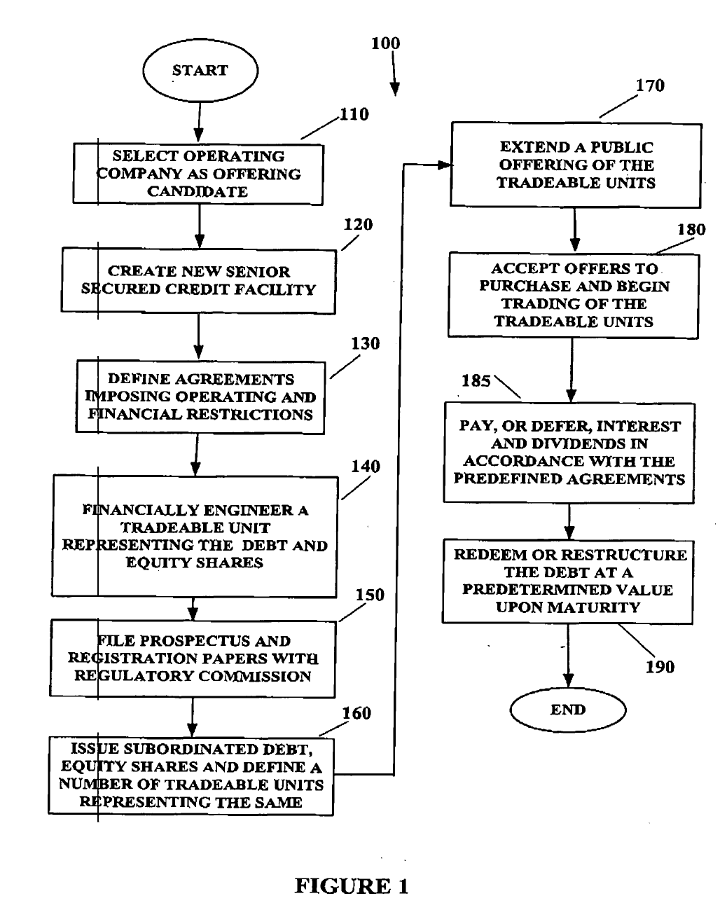

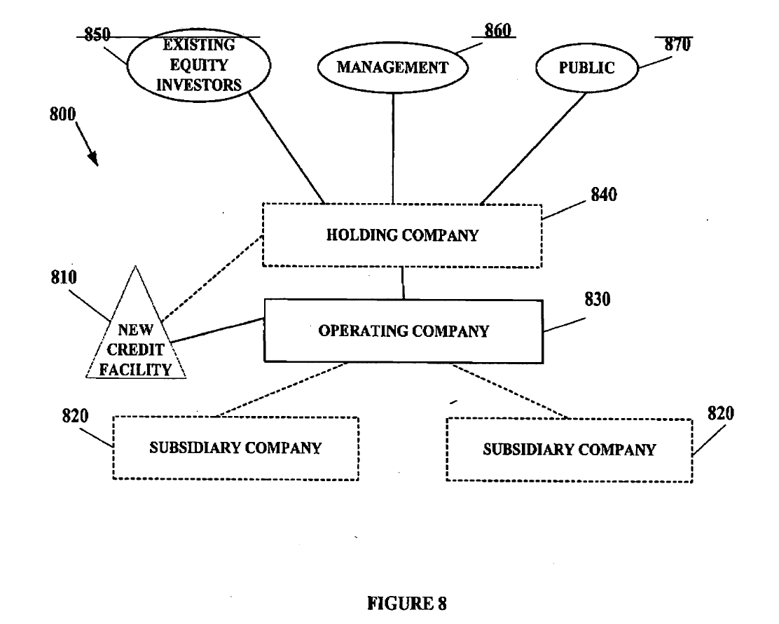

FIG. 1 presents a flow diagram for Process 100, which is a method in accordance with an embodiment of the invention. In conjunction with FIG. 1, FIG. 8 depicts one form into which the capital structure of an operating company can be organized after undergoing Process 100 of FIG. 1.

With reference to FIG. 8, the capital structure 800 of the operating company 830 is shown. A new credit facility 810 contains senior debt and provides the company with a revolving credit facility and/or a term loan. Optionally, the operating company 830 wholly owns subsidiary companies 820, which are depicted in dashed outline. In one embodiment the operating company is wholly owned by a holding company 840, depicted in dashed outline. The holding company 840 may have no operations itself, but owns an interest in the operating company. Therefore, the holding company is dependent on the cash flow of the operating company, and any subsidiaries, to meet its own obligations. If the capital structure 800 includes the holding company, the new credit facility 810 is an obligation of the holding company 840; this obligation is depicted in dashed line. The operating company 830, or the holding company 840, if present, issues tradeable units representing the equity and debt of the company in accordance with Process 100 of FIG. 1. Holders of the tradeable units can be the Existing Equity Investors 850, Management 860 and/or members of the Public 870 participating in the offering. Alternatively, the Existing Equity Investors may own shares of common stock or preferred stock. The three groups of holders can be in any proportion, but a typical distribution could be about 18% to Existing Equity Investors, 2% to Management and 80% to the participating Public.

The following discussion describes Process 100 in FIG. 1 and refers to the structures depicted in FIG. 8. At step 110, the operating company 830 is selected as the candidate for the offering of tradeable units. As previously detailed, the ideal candidate operating company is among the leaders in its business sector and has a diversified client base, preferably one that is obligated by long-term and exclusive contracts with the company, and a stable and predictable stream of revenues and cash flows. At step 120, the new credit facility 810 is created having secured senior debt. The company 830, or optionally the holding company 840, enters into a new credit facility 810 and guarantees the new credit facility to the lenders on a senior basis. Credit facility 810 provides either a revolving credit facility or a term loan facility, or both. The new credit facility 810 assures that the company's management will have a discretionary source of accessible capital.

With the formation of the credit facility 810, the company enters into agreements, step 130, defining and imposing operational and financial restrictions. These agreements restrict the company management in making certain financial decisions so that the interests of the senior creditors of the credit facility 810 are protected. Holders of the tradeable units are subject to covenants recited in these agreements. The new credit facility agreements restrict the ability of the company, under certain circumstances, to pay interest on subordinated debt and to pay dividends on its equity. However, the new credit facility, as a preferred modest departure from standard credit facility agreements, does not obligate the company to retain capital which is in excess of its senior debt obligation within the company, and instead permits the company to pay interest on the subordinated debt and dividends on the equity within the tradeable unit when conditions allow. The terms contained within these agreements, such as the clause above, are of a nature that modestly depart from the more standard terms typically found in such senior credit facilities, however, they do not create any obstacle which a person of ordinary skill in the art cannot overcome in placing the new credit facility among financial institutions.

In FIG. 1, at step 140, a tradeable unit of the preferred embodiment is financially engineered to represent an amount of subordinated debt and common stock that results in a current yield based on combined interest on the subordinated debt and dividends on the common stock which is desirable to investors. A predetermined ratio of one share of common stock to an amount of subordinated debt is selected to provide a desirable return on investment. Current market conditions and leverage levels in public leveraged transactions determines the maximum amount of subordinated debt available to the company. Typically, the company issues a portion (approximately 10%) of the issued subordinated debt to the public separately, i.e., outside of the IDS structure, at the time the tradeable units are issued. The subordinated debt can be notes, bonds, debentures or promissory notes issued by the company having a principal value and a rate of interest ascribed thereto. Preferably, the subordinated debt is guaranteed by one or more subsidiaries of the issuing company, but on an unsecured subordinated basis.

The following considerations can constitute the financial engineering associated with determining the predetermined ratio in one embodiment of a tradeable unit. First, as is understood by persons of skill in the art, prevailing market conditions determine the interest rate payable by newly issued debt. Second, the value associated with an amount of the company's equity, such as in the form of shares of common stock, is dependent on market conditions of a different nature. The value of a share of stock is based on a large number of factors, including but not limited to the percentage of ownership in the company the share represents and the amount of debt outstanding under the new capital structure. The company's value, although based on multiple quantifiable factors (e.g., priceearnings ratio, net asset value, enterprise value to cash flow) is also partly based on unquantifiable factors including market condition and investors' perception of the company or of the offering being made.

Owners of a privately held company desiring to raise public capital through the use of this tradeable unit structure first determine the gross amount of capital they wish to raise in the offering. This capital structure requires the issuance of both a quantity of equity in the company and debt of the company. A determination is made of the amount of cash flow available for interest payments on the subordinated debt and dividend payments on the equity shares, which are both to be represented by the IDSs. A target initial yield per IDS unit is chosen reflecting the weighted average of the current market interest rate on the subordinated debt and a target dividend yield on the equity shares. Dividing the amount of cash flow available for interest on the subordinated debt and dividends on the equity shares by the previously chosen target IDS yield results in the total value of all the IDSs which can be registered. Based on the foregoing, a person of skill in the art can understand that the offering price per IDS is determined by the prevailing market conditions.

The amount of equity ownership to be offered can be determined by equating the offering's ownership percentage to the value of the company as a whole. For example, the value of the equity shares to be represented by the IDSs is calculated as the value of the total IDSs outstanding (i.e., the amount of IDSs to be registered) less the amount of subordinated debt represented by the IDSs. The value of such equity shares can be in addition to the value of any other equity held separately (i.e., outside the IDS structure). The corresponding initial dividend yield on the equity shares represented by the IDSs is then the estimated annual dividends payable to IDS holders, based upon a stated dividend policy adopted by the Board of Directors of the company, divided by the total initial value of the equity represented by the IDSs.

Because the candidate company for the offering is preferably a relatively stable and predictable business, it is able to prudently distribute nearly all its free cash flow to the holders of the IDSs in the form of interest and dividend payments. The portion of the cash flow needed for debt service in the form of interest payments to IDS holders is calculable from the principal value of the debt and its interest rate. The balance of the free cash flow is then available to be distributed as dividend payments to holders of the equity. This process can repeated and adjusted until a balance of the principal value of debt, the percentage of ownership in the offering, and the dividend and interest payments sufficiently satisfy financial market conditions.

By way of example, in accordance with the above embodiment, a company issues equity in the form of common shares having a value of $9.00 per share, and paying a dividend of 8.3% annually. The company also issues subordinated debt with a predetermined principle value of $6.00 per subordinated note paying interest at a rate of 13.5% annually. The IDS can represent one share of common stock ($9.00 value) and $6.00 principal amount of a subordinated note, thus, the initial value of each IDS would be $15.00. This value for an IDS is selected based on criteria known to persons skilled in the art of finance marketing—e.g., what will investors be willing to pay for portions of ownership interest. The holder of such an IDS would be paid $0.75 in annual interest and $0.81 in annual dividends, totaling $1.56 annually. Thus, the IDS would initially yield the holder $1.56/$15.00 or 10.4% annually. The amount of subordinated debt and equity represented by a unit of the IDS is allocated in a predetermined manner, so that the amount of IDSs sold to the public multiplied by their offering price equals the value of capital to be raised in the IDS offering.

Referring again to FIG. 1, as is known in the art, a registration statement containing a prospectus is filed with the Unites States Securities and Exchange Commission (SEC), step 150, seeking approval for the public issuance of equity and debt by the company. After obtaining regulatory permission to proceed, the company and its underwriters then solicit offers to purchase the equity and the debt constituted to form the tradeable units, step 160. At step 170 public solicitation for offers to purchase are extended. After sufficient offers to purchase are generated, the registration statement is declared effective by the SEC, the price for the tradeable units is set by the underwriters and the offers to purchase from the public are accepted and confirmed. Typically, the tradeable units begin trading on a national securities exchange immediately thereafter, and a closing occurs several days later, step 180.

Prospectuses or offering documents to be filed in other countries are similarly submitted to the proper regulatory agency having jurisdiction over these matters within those other nations. After approval, the process of soliciting offers to purchase through the initial trading of the units follows the approach outlined above, but adjusted as necessary to conform precisely with local regulations.

Each of the common stock, subordinated debt and tradeable units are themselves considered separate securities under the Securities Act of 1933, and as such are each registered for sale under the registration statement referred to above. Each of the common stock, subordinated debt and tradeable units are assigned references that make each security uniquely identifiable. As is known in the art, the Committee on Uniform Securities Identification Procedures (CUSIP) has devised a numbering system to uniquely identify securities. A CUSIP number identifies most securities, including: stocks of all registered U.S. and Canadian companies, bonds and notes of U.S. companies, other securities of U.S. companies, and U.S. government and municipal bonds and notes. The CUSIP system—owned by the American Bankers Association and operated by Standard & Poor's—facilitates the clearing and settlement process of securities. The number consists of nine characters (including letters and numbers) that uniquely identify a company or issuer and the type of security. The CUSIP number is unique to each security and facilitates the clearing and settlement of any purchases and sales of a security. A unique CUSIP is assigned to each of the common stock, the subordinated debt and the tradeable unit.

The Deposit Trust Corporation's (DTC) UNIT system is applicable to implementing the offering of tradeable units representing the subordinated notes and equity (i.e., shares of common stock), collectively referred to herein as “securities.” The DTC UNIT system associates a CUSIP number with the security certificate numbers. The UNIT system will associate any tax consequence arising from Original Issue Discount (OID) to the debt. Further, the DTC UNIT system is capable of accommodating follow-on issuances of tradeable units that are fungible with the initial IDS offering, in accordance with another embodiment of the invention described below.

The system implemented by DTC brings efficiency to the securities industry by retaining custody of some two million securities issues. By representing securities through CUSIP numbers, DTC effectively “dematerializes” the securities, so that they exist as electronic files rather than as countless pieces of paper. The CUSIP number is a software reference stored in a record of a hierarchal computer database. Other data which could be stored in records under the hierarchy associated with a CUSIP number are the certificate numbers of the securities, whether Original Issue Discount exists for debt, and other parameters.

DTC is a limited purpose trust company organized under the laws of the State of New York, a “banking organization” within the meaning of the New York State Banking Law, a member of the Federal Reserve System, a “clearing corporation” within the meaning of the Uniform Commercial Code and a “clearing agency” registered under Section 17A of the Securities Exchange Act of 1934. DTC was created to hold securities for its participants and to facilitate the clearance and settlement of securities transactions between its participants through electronic book-entry changes to the accounts of its participants. DTC's participants include securities brokers and dealers, including the underwriters, banks and trust companies, clearing corporations and other organizations. Indirect access to DTC's system is also available to others such as banks, brokers, dealers and trust companies. These indirect participants clear through or maintain a custodial relationship with a DTC participant, either directly or indirectly. The rules that apply to DTC and its participants are on file with the SEC.

DTC has no knowledge of the actual beneficial owners of the securities. DTC's records reflect only the identity of the direct participants to whose accounts such securities are credited, which may or may not be the beneficial owners. The participants are responsible for keeping account of their holdings on behalf of their customers. Transfers of ownership interests in the securities are accomplished by entries made on the books of participants acting on behalf of beneficial owners. Beneficial owners do not receive certificates representing their ownership interests in the applicable security except in the event that use of the book-entry system for the securities is discontinued.

Holders of IDSs are the beneficial owners of the common stock and subordinated notes represented by the IDSs. Through their broker or other financial institution and DTC, holders have exactly the same rights, privileges and preferences as any other owner of common stock and subordinated debt. These rights, privileges and preferences include, but are not limited to, voting rights, rights to receive distributions, rights and preferences in the event of a default under the indenture agreement governing the subordinated notes, ranking upon bankruptcy and rights to receive communications and notices.

Retaining the holders' direct ownership interests in the equity and debt represented by the tradeable units is a distinguishing feature over the conventional financial units previously available. In particular, companies could gain access to the IPO marketplace by issuing subordinated debt and common shares to an income trust which was organized exclusively for this purpose. Conventional trust certificates are then sold to the investing public, but these certificates did not give their holders any direct ownership interest in either the equity or the subordinated debt of the company. Instead, the holders merely held an ownership interest in the trust itself, which derives its income from the interest and dividend owed to the trust as the owner of the equity and debt interests. Thus, the trust is a holding entity which is disposed between the trust certificate holder and the underlying equity and debt. A salient aspect of the present invention, which markedly departs from the prior art, is that holders of the tradeable unit have a direct ownership interest in the underlying equity and debt without the interposition of a holding entity and free of any trust certificates.

Preferably, the IDSs are posted in book-entry form only, and a nominee of the book-entry clearing system is the sole registered holder of the IDSs. Holders of the IDSs are therefore not a registered holder and do not receive a certificate evidencing the holder's right to the IDSs. Reliance is placed on the holder's individual broker or financial institution, which maintains the book-entry position, to receive the benefits and exercise the rights of a holder of IDSs.

DTC, or an equivalent depositary, acts as a securities depository for the IDSs The subordinated notes and the shares of company common stock represented by the IDSs can be represented by one or more global notes and global stock certificates. The global notes and global stock certificates are issued in fully-registered form in the name of the depositary's nominee; DTC's nominee being Cede & Co.

Purchase of the IDSs is preferably conducted in accordance with the Book Entry Procedures of the DTC system or through direct and indirect participants, including The Canadian Depository for Securities Limited (CDS). The participant that a holder purchases through will receive a credit for the applicable security on DTC's records. If a purchase of an IDS is made in Canada, the holder will hold the interest in the IDS through a dealer which is a registered CDS participant, and through the DTC participant account maintained by CDS. The ownership interest of each actual purchaser of the applicable security, known as a “beneficial owner,” is recorded on the participant's records. Beneficial owners do not receive written confirmation from DTC of their purchases, but beneficial owners receive written confirmations providing details of their purchase and sale transactions, as well as periodic statements of their holdings, from the DTC or CDS participant through which the beneficial owner entered into their purchase and sale transactions.

With further reference to FIG. 1, after issuance of the tradeable unit, the company is obligated to pay interest, step 185, in accordance with the predefined agreements entered into at step 130. In addition, it is anticipated that the company's Board of Directors will establish a dividend policy and declare dividends at the rate specified in the Prospectus. Upon maturity of the debt, step 190, the company at its option can redeem the debt by paying the holders the principal value. Alternatively, the company can refinance the debt by issuing a new subordinated debt, borrowing from the credit facility 810, or by applying other debt refinancing techniques known in the art.

As described above the tradeable unit represents a ratio of equity, in the form of common stock, to a principal amount of subordinated debt, in the form of a note, bond, a promissory note, or a debenture. The ratio of equity to debt represented by an IDS is subject to change in the event of a stock split, recombination or reclassification of the company's common stock. For example, if the company undergoes a two-for-one stock split, from and after the effective date of the stock split, each IDS will represent twice the shares of common stock and the same principal amount of subordinated debt as it previously represented. The DTC UNIT system accommodates this event by assigning each new share of common stock with the already existing CUSIP number. Likewise, if the company effects a recombination or reclassification of its common stock, each IDS will thereafter represent the appropriate number of shares of common stock on a recombined or reclassified basis, as applicable, and the same principal amount of subordinated notes as it previously represented. Following the occurrence of any such event, the company typically discloses to the appropriate regulatory agency the changes in the ratio of common stock to principal amount of subordinated notes as a result of such event. For instance, a Current Report on Form 8-K would be filed with the SEC. Similarly, other jurisdictional requirements are complied with by filing the necessary appropriate documentation with that jurisdiction's regulatory agency.

Holders of IDSs can voluntarily separate or recombine their IDSs. Preferably, the predefined agreements assure that there is a lock-up period after the initial offering of the IDS units and after the occurrence of a change of control, during which a separation can not be performed. Preferably the lock-up period is on the order of forty-five days. Holders of IDSs can, through their broker or other financial institution, separate the IDSs into the shares of equity and subordinated debt represented by the IDS. Further, any holder of shares of the company's common stock and subordinated debt may, at any time, through their broker or other financial institution, combine the necessary number of shares of common stock and subordinated notes to form IDSs.

In accordance with an embodiment of the IDS, upon the occurrence of certain events the IDSs are automatically separated into the shares of common stock and subordinated notes represented thereby. Exemplary events triggering automatic separation include the exercise by the company of its right to redeem all or a portion of the subordinated notes, which may be represented by IDSs at the time of such redemption; arrival of the date on which principal on the subordinated notes becomes due and payable, whether at the stated maturity date or upon acceleration thereof; or if DTC is unwilling or unable to continue as securities depository with respect to the IDSs or ceases to be a registered clearing agency under the Securities Exchange Act of 1934 and a successor depositary is not available.

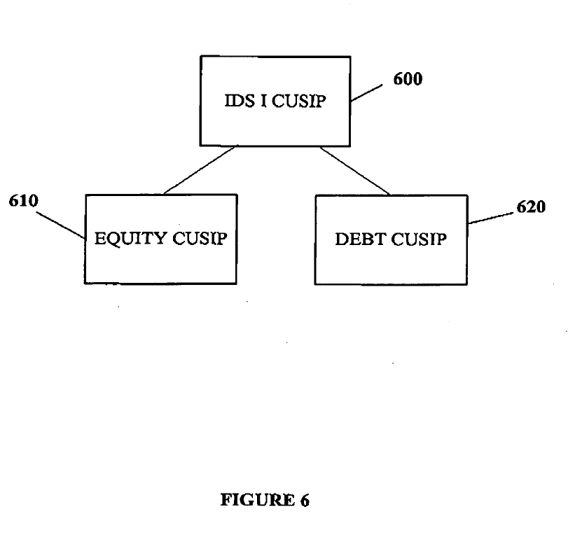

FIG. 6 illustrates the structure of the tradeable unit offered under Process 100. At the time of the initial public offering of a tradeable unit the following three CUSIP numbers are assigned: IDS I CUSIP 600, Equity CUSIP 610 and Debt CUSIP 620. The IDS I CUSIP 600 identifies the tradeable unit held by the public, and represents a financially engineered ratio of equity and debt (e.g., common stock and notes). The Equity CUSIP 610 identifies the common stock owned by the holder of the IDS, and similarly, the Debt CUSIP 620 identifies the subordinated debt owned by the holder of the IDS. In one embodiment, Debt CUSIP 620 can represent an original tranche of notes. The IDS I CUSIP 600 is suitable for being publicly traded on a stock exchange, e.g., the American Stock Exchange (AMEX), the New York Stock Exchange (NYSE) or the Toronto Stock Exchange. Each holder of IDS I CUSIP can separate the IDS I CUSIP and receive a position in the constituent securities (Equity CUSIP 610 and Debt CUSIP 620).

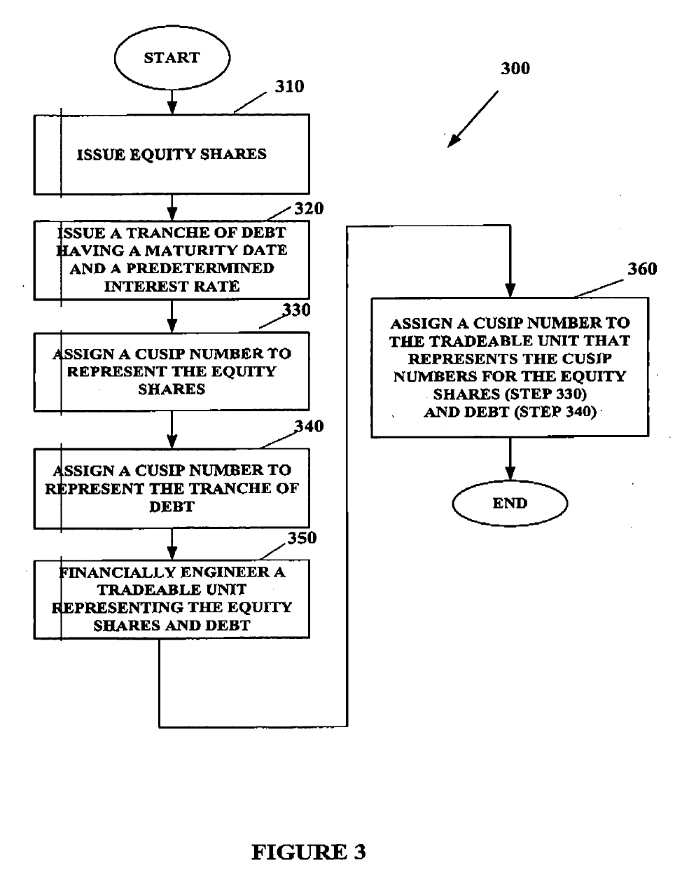

FIG. 3 depicts Process 300, which illustrates the steps of creating the structure of IDS I CUSIP 600. At step 310, equity shares, for example common stock, are issued, and, at step 320, a tranche of debt with a predetermined maturity date and a particular interest rate is issued. The particular interest rate is pre-designated and may be either a fixed rate or one that varies with respect to a financial benchmark or reference, as is known in the art. At steps 330 and 340, CUSIP numbers representing the equity and debt are assigned. The equity and debt are financially engineered, step 350, in the predetermined manner described above, to obtain a predetermined ratio. At step 360, a CUSIP number is assigned to tradeable units that represent the CUSIP numbers for the equity and debt.

In accordance with one embodiment, the DTC UNIT system can accommodate follow-on (i.e., subsequent) offerings by issuing new securities under a new CUSIP number, while automatically, and simultaneously, exchanging a portion of the holders' interests in the initial IDS units for like interests in the follow-on or subsequent offering of IDS units. This feature also distinguishes the tradeable units over the current art where notes are presently issued in a follow-on offering under a new CUSIP number, due among other reasons to the potential presence of Original Issue Discount (OID).

OID is a tax consequence attributable to an investment in a note, bond, or other type of debt instrument when such instrument is issued at a discount to its par or stated value. If interest rates have risen since the initial IDS offering, the notes which comprise part of the IDS may have a discounted market value, determined by market conditions. In order to achieve fungibility of the new notes with the old notes, the new notes are issued at the same interest rate as the preexisting notes, and must be issued at a discount to face value so as to reflect the current, higher market interest rate. Upon maturity, the face value of the new note is paid to the holder. Thus, a holder of a note with OID gets a return on investment which is equal to the prevailing interest rate through a combination of (1) cash interest paid out over the term of the discounted note, plus (2) the accretion from purchase price to face value received at the note's redemption.

For example, a company issues a debenture having a ten year term and paying interest at 8% annually. The interest rate is determined by the prevailing market conditions which is influenced by the U.S. Treasury rate, a credit spread between the Treasury rate and market demand, the company's own credit worthiness and the term of the debt. Say, three years later, the company wants to issue additional debt and the prevailing interest rate has increased. In order for the two series of debt to be identical, the second debt needs to be issued at the same stated interest rate as the first and have the same maturity date. However, investors will not be willing to purchase the second debt if it is paying the same interest rate as the first debt (8%) at a time when the market is demanding higher rates. To overcome this problem the second debt is sold at a discount from face value. Upon maturity, the second debt will be redeemed at face value, although it was sold at a discount to face value. An investor holding the debt until maturity will receive the sum of interest payments over time plus the face value of the debt, such that the yield is equivalent to the prevailing interest rate being demanded by the marketplace at the time of issuance. The movement of a debt's discounted purchase price at the time of issue, to the full face value at redemption is known as accretion. The second debt is assigned its own unique CUSIP number which tracks the associated accretion, or OID attached to the debt.

The two series of debt equate economically and give current buyers of either the rate of return then prevailing in the marketplace. The actual notes themselves will be identical in every respect, except because the new debt was issued at a discount from its stated value and accretes over time, its carries OID for federal income tax purposes associated with its CUSIP.

In the follow-on embodiment of IDS there is a need to homogenize, to the extent possible, the two series of debt. This need is new and has never existed in the marketplace before. This need now exists because the two series of debt are to be associated with equity in the follow-on tradeable unit which represents the debts and equity.

If the Issuer issues additional IDSs in a follow-on offering and the debt issued in connection therewith can be sold without OID, such issuance of debt could be made under Debt CUSIP 620. Additional common stock would be issued under the Equity CUSIP 610, and additional IDSs would be issued under the IDS I CUSIP 600. However, if there has been a change in the interest rate market at the time an Issuer issues additional IDS in a follow-on offering, the debts issued in connection therewith may need to be sold with OID or at a premium.

When prevailing interest rates have fallen since the issuance of the initial series of debt, the second debt will be sold at a premium. The subsequent series of debt would be issued paying the same interest rate as the first series of debt, but are sold at a premium above its stated face value. A holder of the note is paid face value at redemption, but having received a higher interest rate during the life of the debt this loss is offset to net the holder the equivalent return of the lower prevailing rate. These two series of debt are identical and indistinguishable, and can be homogenized together to form the debt portion of a subsequent tradeable unit.

In addition to the foregoing, another innovation of the tradeable unit is a customized feature of the debt itself. Unlike most typical debt, the debt paired with the common stock to form the tradeable unit has a more customized Restricted Payment Test (i.e., Dividend Blocker Test) which if not customized, would otherwise prevent dividend payments being made to the holders of the common stock. The IDS debt component has a tailored and customized Restricted Payment Test which allows for a sufficient amount of the company's free cash flow after payment of interest on the debt to be paid as dividends on the common stock.

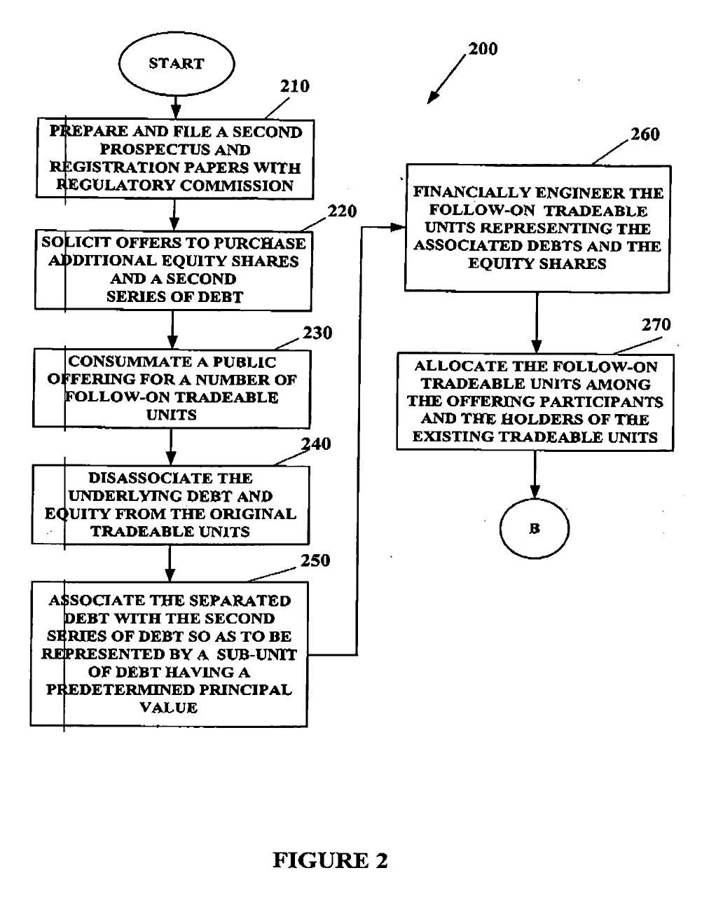

FIG. 2 illustrates Process 200, which is a method for creating tradeable units suitable for use in a follow-on or subsequent offering. After a company has issued IDSs, the management may decide to raise more capital by engaging in a subsequent offering of IDS units. The company then must define a capital structure for the subsequent offer. This capital structure requires the issuance of additional equity shares in the company and additional debt of the company. At step 210, a second registration statement is prepared and filed with the SEC. The company then, through its underwriters, solicits offers to purchase additional shares of common stock and a second series of subordinated debt, step 220, in predetermined amounts so as to raise the desired amount of capital. The second series of debt bears the same maturity date and interest rate as the already issued debt. After sufficient demand for the offering is generated, the offering is consummated step 230.

In order for the IDSs of the subsequent offering to be fungible with the IDSs issued in the earlier offering, it is necessary for the IDSs already in the market to be “blended” with the follow-on IDSs to create a homogenous pool of IDSs comprising both the earlier and the subsequent issues. Thus, as a salient part of this embodiment of the present invention, holders of the initial offering of IDSs, by their purchase, give their consent to, in the future, permit automatic and simultaneous recall and replacement of the existing IDSs upon the issuance of follow-on IDSs with a “blend” of original IDSs and subsequent IDSs in the correct ratio. At step 240, the reference numbers which represent the underlying equity and debt of the original IDSs are disassociated from the reference number which represents the existing IDSs. The reference numbers for the separated debt of the already issued IDS and the second series of debt are associated together, step 250, under a single reference number to form a sub-unit which contains a predetermined amount of principal value. The debt sub-unit and the equity shares are then financially engineered, step 260, in the manner previously described, to obtain a predetermined ratio and a predesignated, particular interest rate. At step 270, the tradeable unit representing the debt sub-unit and the equity shares is allocated automatically and simultaneously to holders of the existing IDSs and participants in the follow-on offering. After issuance of the subsequent offering, the company pays or defers interest and dividends in accordance with the predefined agreements, and redeems or restructures the debt upon maturity. As described above, the follow-on embodiment of the tradeable unit is issued with debt that can be effectively “homogenized” so that the first and second series of debts represented by the follow-on tradeable unit are fungible.

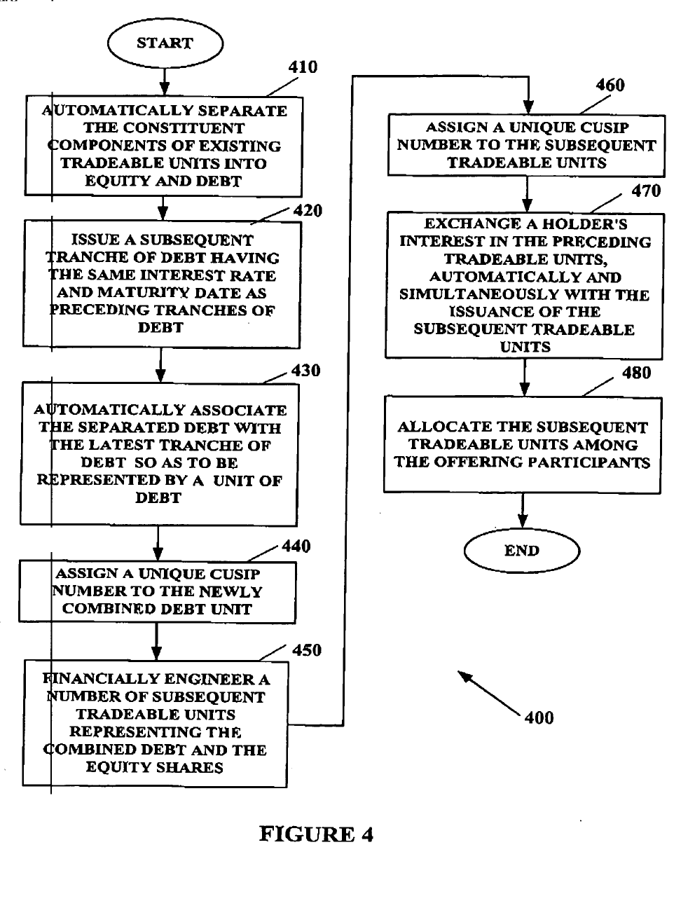

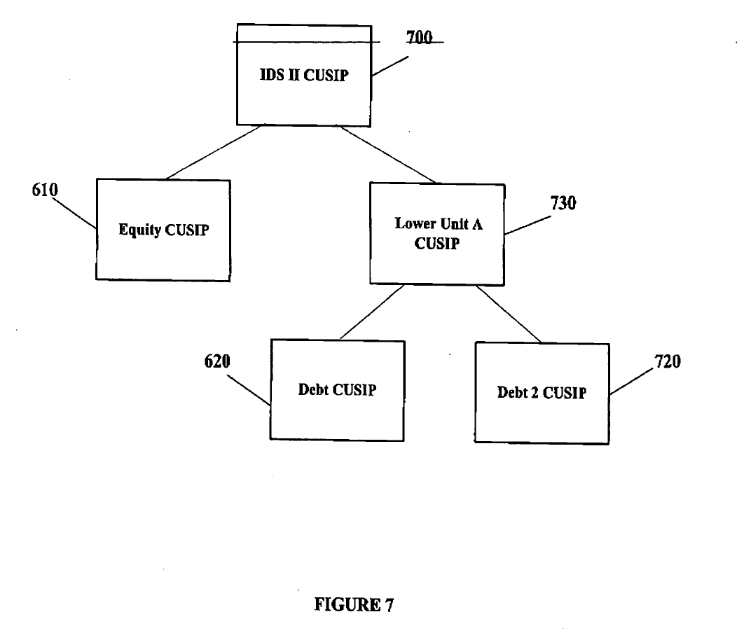

FIG. 4 illustrates Process 400, which creates the follow-on tradeable unit. At step 410, all existing IDS units, exemplary represented by IDS I CUSIP 600, will be automatically separated into the constituent securities of Equity CUSIP 610 and Debt CUSIP 620. New notes are issued, step 420, under a new CUSIP number, e.g., Debt 2 CUSIP 720 as depicted in FIG. 7. The old notes of Debt CUSIP 620 and the new notes of Debt 2 CUSIP 720 automatically will be associated, step 430, with a newly established indivisible unit, Lower Unit A CUSIP 730 of FIG. 7, which has its own unique CUSIP number assigned at step 440. The Lower Unit A CUSIP comprising Debt CUSIP 620 and Debt 2 CUSIP 720 is financially engineered, step 450, in the proportions of the principal amount of Debt CUSIP 620 to the principal amount of Debt 2 CUSIP 720. A new tradeable unit, IDS II CUSIP 700, with its own unique CUSIP number, step 460, replaces IDS CUSIP 600. At steps 470 and 480, the new IDS II CUSIP 700 is credited to the accounts of all prior holders of IDS CUSIP 600 and purchasers participating in the follow-on offering.

FIG. 7 depicts the structure of the follow-on IDS that is created by Process 400. As described above, the IDS II CUSIP 700 comprises common stock represented by Equity CUSIP 610, and the Lower Unit A CUSIP 730, which in turn associates Debt CUSIP 620 and Debt 2 CUSIP 720.

If the company so chooses, any additional follow-on offerings involving the issuance of new notes with significant OID can be made in substantially the same way as described above. Such a subsequent follow-on offering requires the separation of both the unit held by the public (e.g., IDS II CUSIP 700) and the unit representing the two previous debt tranches (e.g., Lower Unit A CUSIP 730), followed by the creation of a new unit, a Lower Unit B CUSIP (not shown) which replaces the Lower Unit A CUSIP, but represents three debt tranches—i.e., Debt CUSIP 620, Debt 2 CUSIP 720 and a Debt 3 CUSIP (not shown). Additionally, a new unit IDS III CUSIP (not shown) is created to replace IDS 11 CUSIP 700, and represents the Equity CUSIP 610 and the new Lower Unit B CUSIP.

In an alternative embodiment, a follow-on subsequent offering retains the CUSIP assigned to IDS I CUSIP 600. Instead of receiving a separate, unique IDS 11 CUSIP 700, the follow-on offering of this embodiment (comprising the EQUITY CUSIP 610 and the Lower Unit A CUSIP 730) encompasses and subsumes the original tradeable unit acquiring IDS I CUSIP 600 as its unique identifying number, simultaneous with the issuance of the follow-on offering. Modifying the ownership interest from the original IDS to the follow-on tradeable unit is done transparently to the holders. The holders' ownership interests are now in the follow-on tradeable unit, and are represented by the same unique CUSIP as before the follow-on unit issued.

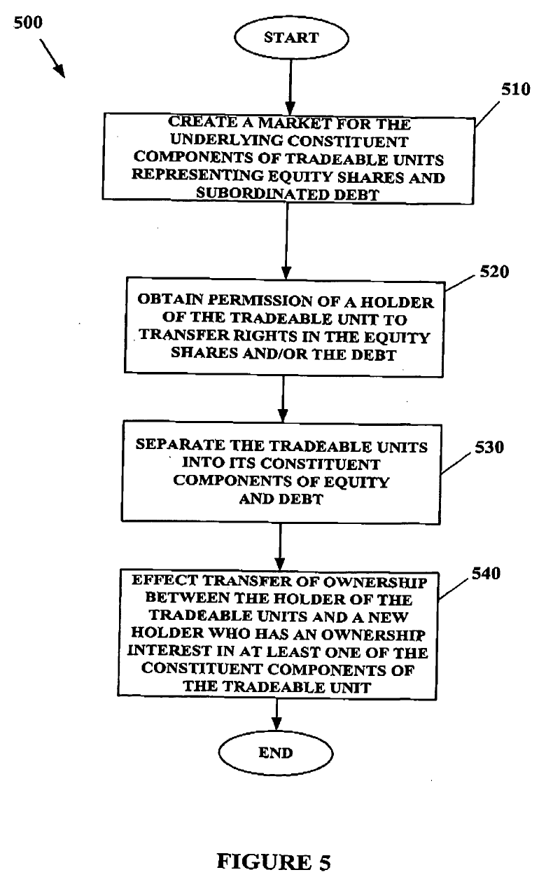

A holder of the IDS is a beneficial owner and has all ownership rights in the equity shares and debt represented by the IDS. Although not a preclusion to separation, a holder of an IDS may desire to sell the constituent components of equity and debt into an existing market. Accordingly, FIG. 5 illustrates Process 500 which comprises the steps of separating the IDS. At step 510, a market for the underlying constituent components of equity and debt of an IDS is created in a financial marketplace. Typically, such a market is created by persons of skill in the art (e.g., underwriters, brokers-dealers or other financial institutions) by methods that are known to such persons. Before an underwriter, broker-dealer or other financial institution can effect a transfer of ownership permission is obtained, step 520, from the holder of the IDS. At step 530, the IDS is separated into its constituent components. Thereafter, at step 540, an ownership interest in the equity constituent, the debt constituent, or both constituents is transferred to a new holder. The holder of the IDS retains interest in the constituent components which were not transferred to the new holder.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one described embodiment to another are also fully intended and contemplated. The invention is defined solely with regard to the claims appended hereto, and equivalents of the recitations therein.

1. An article suitable for trade as a unit, comprising:
one or more equity shares in a company which is capable of paying dividends; and
debt of the company which is interest bearing at a particular rate until a particular maturity date, said equity shares and said debt being represented by the unit in a prescribed way according to a predetermined ratio;
wherein the unit provides direct ownership of said equity shares and said debt.

2. The article of claim 1, wherein an identifying reference is associated with the unit.

3. The article of claim 2, wherein the identifying reference has a unique number associated therewith to facilitate clearing and settlement of purchases and sales of the unit.

4. The article of claim 1, wherein the debt comprises at least one instrument selected from the group consisting of: a note, a bond, a promissory note, an interest bearing obligation, and a debenture; and
wherein the equity shares comprises at least one instrument selected from the group consisting of: common stock, preferred stock, and an ownership interest in the company.

5. The article of claim 1, wherein the unit represents the equity shares and the debt free of any trust certificate(s).

6. The article of claim 1, wherein the debt is a subordinated debt.

7. An article suitable for trade as a unit in a subsequent offering, comprising:
one or more equity shares in a company which is capable of paying dividends;
a first debt of the company which is interest bearing at a particular rate until a particular maturity date;
a second debt or the company which is interest bearing at the particular rate until the particular maturity date; and
said first and second debts and the equity shares being represented by the unit in a prescribed way according to a predetermined ratio;
wherein the unit provides direct ownership of said first and second debts and the equity shares.

8. The article of claim 7, wherein one of the first debt and the second debt is included in the unit at one of a par value, an original issue discount, and an original issue premium.

9. The article of claim 7, wherein the subsequent offering is for a quantity of units and wherein the second debt has an aggregate principal value within the unit which is in proportion to the quantity of units in the subsequent offering.

10. The article of claim 7, wherein the first debt and the second debt are represented by a joint identifying reference associated with a sub-unit.

11. The article of claim 10, wherein the equity shares and the sub-unit are represented by a second joint identifying reference associated with the unit.

12. The article of claim 11, wherein the second joint identifying reference comprises a unique number associated therewith to facilitate clearing and settlement of purchases and sales of the unit.

13. The article of claim 7, wherein the first and the second debts and the sub-unit each have a respective CUSIP number and wherein the unit has a CUSIP number that is different than said respective CUSIP numbers.

14. The article of claim 7, wherein the first and second debts each comprise at least one instrument selected from the group consisting of: a note, a bond, a promissory note, an interest bearing obligation, and a debenture; and
wherein the equity shares comprises at least one instrument selected from the group consisting of: common stock, preferred stock, and an ownership interest in the company.

15. The article of claim 7, wherein the unit provides direct ownership of said equity shares and said debt free of any trust certificate(s).

16. The article of claim 7, wherein at least one of the first debt and the second debt comprises a subordinated debt.

17. An article suitable for trade as a unit, comprising:
a quantity of equity shares in a company which is capable of paying dividends;
an amount of debt of the company which is interest bearing at a particular rate until a particular maturity date; and
a software reference associating the quantity of equity shares and the amount of debt to a single, unique number suitable for facilitating the clearing and settlement of any purchases and sales of the unit.

18. The article of claim 17, wherein the unit provides direct ownership of said equity shares and said debt free of any trust certificate(s).

19. A method of establishing an article suitable for trade as a unit in an offering by a company, comprising the steps of:
defining a capital structure for the unit which includes equity shares in the company and debt of the company in a predetermined ratio;
submitting a request to register the equity shares and the debt for the offering by the company;
requesting the association of the registered equity shares and the debt together in a prescribed way according to the predetermined ratio;
depositing the registered debt and equity shares together under a single, unique number suitable for facilitating the clearing and settlement of any purchases and sales of the unit; and
offering the unit for purchase and sale.

20. The method of claim 19, wherein the differing step comprises a public offering.

21. The method of claim 19, wherein the equity shares are capable of paying dividends, and wherein the debt is interest bearing at a particular rate until a particular maturity date.

22. The method of claim 19, wherein the offering is made free of any trust certificate(s).

23. A method of establishing an article suitable for trade as a unit in a subsequent offering by a company, where a prior offering established a first unit representing equity shares and debt in a predetermined ratio, comprising the steps of:
defining a capital structure for a second unit which includes additional equity shares in the company and additional debt of the company according to the predetermined ratio;
submitting a request to register the additional equity shares and the additional debt for the subsequent offering by the company;
recalling the first unit, the first unit comprising equity shares in the company and debt of the company in the predetermined ratio as its constituent components;
requesting the disassociation of the constituent components represented by the first unit;
requesting the association of the constituent components together with the registered additional equity shares and the additional debt in a prescribed way according to the predetermined ratio;
depositing the constituent components together with the registered additional equity shares and the additional debt under a single, unique second number suitable for facilitating the clearing and settlement of any purchases and sales of a second unit; and
offering the second unit for purchase and sale.

24. The method of claim 23, wherein one of the first debt and the second debt is included in the unit at one of a par value, an original issue discount, and an original issue premium value.

25. The method of claim 23, wherein the offering step comprises a public offering.

26. The method of claim 23, wherein the first number and the second number are the same unique number.

27. The method of claim 23, wherein the subsequent offering is made free of any trust certificate(s).

28. A method of marketing constituent components of an article that is traded as a unit, comprising the steps of:
obtaining dominion over the unit from a holder of the unit, wherein a unique identifying reference number is associated with the unit which jointly represents equity and debt of the company as its constituent components;
separating the unit into the constituent components of equity and debt; and
effecting the transfer of ownership of at least one of the equity and debt.

29. The method of claim 28, wherein the debt is a subordinated debt.

30. An article suitable for trade as a unit, useful in a subsequent offering by a company, comprising:
a quantity of equity shares in the company which is capable of paying dividends;
a first amount of debt of the company which is interest bearing at a particular rate until a particular maturity date;
a second amount of debt of the company which is interest bearing at the particular rate until the particular maturity date;
said first and second debts and the equity shares being represented by the unit in a prescribed way according to a predetermined ratio; and
a software reference associating the quantity of equity shares and the amounts of first and second debt to a single, unique number suitable for facilitating the clearing and settlement of any purchases and sales of the unit.

31. The article of claim 30, wherein the unit provides direct ownership of said equity shares and said first and second debts free of any trust certificate(s).

32. An article suitable for trade as a unit, comprising:
at least one computer database record representing one or more equity shares in a company which is capable of paying dividends, and debt of the company which is interest bearing at a particular rate until a particular maturity date; said equity shares and debt being represented in a prescribed way according to a predetermined ratio, the database record including an entry identifying a registered holder of the unit.

33. The article of claim 32, wherein the database record contains an identifying reference that is associated with the unit.

34. The article of claim 33, wherein the identifying reference comprises a unique number to facilitate clearing and settlement of purchases and sales of the unit.

35. The article of claim 32, wherein the debt comprises at least one instrument selected from the group consisting of: a note, a bond, a promissory note, an interest bearing obligation, and a debenture; and
wherein the equity shares comprises at least one instrument selected from the group consisting of: common stock, preferred stock, and an ownership interest in the company.

36. The article of claim 32, wherein the unit represents the equity shares and the debt free of any trust certificate(s).

37. The article of claim 32, wherein the debt is a subordinated debt.

38. An article suitable for trade as a unit in a subsequent offering, comprising:
at least one computer database record representing a first debt of the company which is interest bearing at a particular rate until a particular maturity date, a second debt of the company which is interest bearing at the particular rate until the particular maturity date, and one or more equity shares in a company which is capable of paying dividends; the equity shares, the first debt, and the second debt being represented in a prescribed way according to a predetermined ratio, the database record including an entry identifying a registered holder of the unit.

39. The article of claim 38, wherein one of the first debt and the second debt is included in the unit at one of a par value, an original issue discount, and an original issue premium.

40. The article of claim 38, wherein the subsequent offering is for a quantity of units and wherein the second debt has an aggregate principal value within the unit which is in proportion to the quantity of units in the subsequent offering.

41. The article of claim 38, wherein the first debt and the second debt are represented by a joint identifying reference associated with a sub-unit.

42. The article of claim 41, wherein the database record contains a second joint identifying reference associated with the unit, the second joint identifying reference representing the equity shares and the sub-unit.

43. The article of claim 42, wherein the second joint identifying reference has a unique number associated therewith to facilitate clearing and settlement of purchases and sales of the unit.

44. The article of claim 41, wherein the first and the second debts and the sub-unit each have a respective CUSIP number and wherein the unit has a CUSIP number that is different than the respective CUSIP numbers.

45. The article of claim 38, wherein the first and second debts each comprise at least one instrument selected from the group consisting of: a note, a bond, a promissory note, an interest bearing obligation, and a debenture; and
wherein the equity shares comprises at least one instrument selected from the group consisting of: common stock, preferred stock, and an ownership interest in the company.

46. The article of claim 38, wherein the unit provides direct ownership of the equity shares and the debt free of any trust certificate(s).

47. The article of claim 38, wherein at least one of the first debt and the second debt comprises a subordinated debt.

48. An article suitable for trade as a unit, comprising:
at least one computer database record containing a software reference associating a single, unique number suitable for facilitating the clearing and settlement of any purchases and sales of the unit with (a) a quantity of equity shares in a company which is capable of paying dividends, and (b) an amount of debt of the company which is interest bearing at a particular rate until a particular maturity date to, the database including an entry identifying a registered holder of the unit.

49. The article of claim 48, wherein the unit provides direct ownership of the equity shares and the debt free of any trust certificate(s).

50. A method of offering for trade a unit representing an ownership interest in the capital structure of a company, the method comprising the steps of:
defining the capital structure for the unit so as to include equity shares in the company and debt of the company in a predetermined ratio;
submitting a request to separately register the equity shares, the debt and the unit for the offering by the company to the public;
requesting the association of the registered equity shares and the debt together in a prescribed way according to the predetermined ratio to form the unit under a single, unique number, which unique number is suitable for facilitating the clearing and settlement of any purchases and sales of the unit; and
offering the unit for purchase and sale.

51. The method of claim 50, wherein the offering step comprises a public offering.

52. The method of claim 50, wherein the equity shares are capable of paying dividends, and wherein the debt is interest bearing at a particular rate until a particular maturity date.

53. The method of claim 50, wherein the offering is made free of any trust certificate(s).

54. A method, operable on a computer-based system, of establishing an article suitable for trade as a unit in a subsequent offering by a company, where a prior offering established a first unit representing equity shares and debt in a predetermined ratio with a single, unique first number, which unique first number is suitable for facilitating the clearing and settlement of any purchases and sales of the first unit, the method comprising the steps of:
defining a capital structure for a second unit which includes additional equity shares in the company and additional debt of the company according to the predetermined ratio;
submitting a request to register the additional equity shares and the additional debt for the subsequent offering by the company;
recalling the first unit, the first unit comprising equity shares in the company and debt of the company in the predetermined ratio as its constituent components;
requesting the disassociation of the constituent components represented by the first unit;
requesting the association of the constituent components together with the registered additional equity shares and the additional debt in a prescribed way according to the predetermined ratio with a single, unique second number, which unique second number is suitable for facilitating the clearing and settlement of any purchases and sales of the second unit using said computer-based system; and
offering the second unit for purchase and sale.

55. The method of claim 54, wherein one of the first debt and the second debt is included in the unit at one of a par value, an original issue discount, and an original issue premium value.

56. The method of claim 54, wherein the offering step comprises a public offering.

57. The method of claim 54, wherein the first number and the second number are the same unique number.

58. The method of claim 54, wherein the subsequent offering is made free of any trust certificate(s).

59. A method, operable on a computer-based network, of marketing constituent components of an article that is traded as a unit, wherein the computer-based network includes a plurality of network-connected computers and a database, the method comprising the steps of:
obtaining dominion over the unit from a holder of the unit, wherein a unique identifying reference number is associated with the unit in the database which jointly represents equity and debt of the company as its constituent components;
separating the unit into the constituent components of equity and debt; and
effecting the transfer of ownership of at least one of the equity and debt using at least one of said computers.

60. The method of claim 59, wherein the debt is a subordinated debt.

61. An article suitable for trade as a unit, useful in a subsequent offering by a company, comprising:
at least one database record containing a software reference associating a quantity of equity shares in the company which is capable of paying dividends, a first amount of debt of the company which is interest bearing at a particular rate until a particular maturity date, and a second amount of debt of the company which is interest bearing at the particular rate until the particular maturity date; the database record representing the associated equity shares and the first and the second debts in a predetermined ratio with a single, unique number suitable for facilitating the clearing and settlement of any purchases and sales of the unit; and wherein the database record includes an entry identifying a registered holder of the unit.

62. The article of claim 61, wherein the unit provides direct ownership of the equity shares and the first and second debts free of any trust certificate(s).

63. A method of offering for trade a unit representing an ownership interest in the capital structure of a company, comprising the steps of:
creating new debt and equity in the company;
representing the debt and equity together in a prescribed way according to a predetermined ratio to form a tradeable unit; and
offering the tradeable unit for purchase and sale.

64. The method of claim 63, further including the step of registering the debt and equity with a regulatory agency.

65. The method of claim 64, further including the step of registering the unit with the regulatory agency.

66. The method of claim 63, further including the step of associating the unit with a single, unique number prior to the step of offering the unit, said number being suitable for facilitating the clearing and settlement of any purchases and sales of the unit.

67. The method of claim 63, wherein the debt is interest bearing at a particular rate until a particular maturity date.

68. The method of claim 63, wherein the equity is designed to pay dividends.

69. The method of claim 63, further including the step of depositing the debt and equity together with a clearinghouse.

70. The method of claim 63, wherein the offering is made free of any trust certificates.

71. The method of claim 63, wherein the offering step comprises a public offering.

72. The method of claim 63, wherein the debt is a subordinated debt.

73. The article of claim 1, wherein the unit is a certificate representing the direct ownership.

74. The article of claim 1, wherein the unit is an electronic book-entry stored in a database record.
